(19) United States
(12) Patent Application Publication
(10) Pub. No.: US 2017/0240083 A1
(43) Pub. Date: Aug. 24, 2017

(54) METHOD FOR PRODUCING A SEAT COVER AND SEAT COVER

(71) Applicant: Adient Luxembourg Holding S.à.r.l., Luxembourg (LU)

(72) Inventors: Uwe SCHULZE, Köln (DE); Lars HENNIG, Leichlingen (DE)

(21) Appl. No.: 15/519,720

(22) PCT Filed: Sep. 28, 2015
(86) PCT No.: PCT/EP2015/072218

§ 371 Date: Apr. 17, 2017

(30) Foreign Application Priority Data
Oct. 17, 2014 (DE) 10 2014 221 161.1

(51) Int. Cl. B60N 2/58

(52) U.S. Cl. CPC B60N 2/5891

(57) ABSTRACT

A method produces a seat cover (2), which seat cover includes at least one body contact surface (7, 9) and seat cushion side surfaces (8.1, 8.2, 10.1, 10.2) which are adjacent thereto. A receiving element (4) is arranged in the region of the blank part (3.1, 3.2) on a raw material (1) prior to cutting a blank part (3.1, 3.2) for the seat cover (2), and is secured. The at least on body contact surface (7, 9) and the adjacent seat cushion side surfaces (8.1, 8.2, 10.1, 10.2) are cut from a raw material (1) as a single-piece blank part (3.1, 3.2) and are processed to form a seat cover (2).

### CROSS REFERENCE TO RELATED APPLICATIONS

This application is a United States National Phase Application of International Application PCT/EP2015/072218, filed Sep. 28, 2015, and claims the benefit of priority under 35 U.S.C. §119 of German Application 10 2014 221 161.1, filed Oct. 17, 2014, the entire contents of which are incorporated herein by reference.

### FIELD OF THE INVENTION

The invention relates to a method for producing a seat cover which comprises at least one body contact surface and adjoining side cheek surfaces. Furthermore, the invention relates to a seat cover for a seat, in particular a vehicle seat.

### BACKGROUND OF THE INVENTION

Methods for producing a seat cover, and seat covers, are generally known from the prior art. U.S. Pat. No. 3,841,700 describes a kit for producing seat covers of front and rear seats or for a backrest and a seat part. Here, semifinished products are pre-sewn which have webs made from different materials for the seat face, side/cover face and the rear side. Said pre-sewn semifinished products are subsequently trimmed and finally sewn in accordance with the specific seat dimensions by means of a predefined cutting sequence.

After laminating, usually a flame laminating process, materials which are provided for a seat cover are wound onto what are known as reels, are packaged and are subsequently dispatched to a trimming unit. At the trimming unit, said materials are cut into the required parts by way of a cutter and are fed to a sewing process.

Furthermore, US 2008/0309143 A1 describes a vehicle seat which has a foamed seat cushion, a flexible cover which forms a surface of the vehicle seat at least partially, and an elastic spacer element.

Moreover, WO 02/052899 A1 describes a panel heating means and a method for producing it, DE 198 47 331 A1 describes a method for attaching fastening elements to a knitted seat cover, FR 2 816 185 A1 describes a method for covering a seat cushion, WO 94/18033 A1 describes an airbag, DE 196 49 427 C1 describes a seat covering, DE 10 2011 016 843 A1 describes a method for producing a vehicle interior trim part, and DE 86 29 570 U describes a cushion covering made from knitted fabric.

### SUMMARY OF THE INVENTION

The invention is based on the object of specifying a method for producing a seat cover, which method is improved in comparison with the prior art, and an improved seat cover.

In the case of the method, a seat cover is produced which comprises at least one body contact surface and side cheek surfaces which adjoin it. According to the invention, before a blank part for the seat cover is cut, at least one receiving element is arranged and fastened on a raw material in the region of the blank part which is still to be cut.

Moreover, the at least one body contact surface and the adjoining side cheek surface are cut to size from the raw material as a single-piece blank part with the at least one receiving element, which blank part forms the seat cover.

By way of the pre-processing of the raw material by way of fastening at least one contour-giving receiving element to the raw material, the production method for seat covers can be automated further and manual processing steps can be reduced. In particular, manual sewing work can be reduced by more than 30%. Furthermore, waste which is produced when the blank parts are cut to size can be reduced considerably. For instance, the waste can be reduced by approximately 40% when a single-piece blank part for a seat cover for the backrest or the seat face of a seat, in particular of a vehicle seat, is cut. Here, the savings vary depending on the material which is used and the design of the seat cover. The overall production process and transport sequences are optimized by way of the further automation and processing by machine of the raw material for producing the seat cover.

In order to make the production process even more efficient, the raw material might be guided into a sewing system for fastening the receiving element by machine directly after the laminating operation, using a material buffer, and afterward might either be rolled up together or might be guided directly further for cutting to size and cutting of the single-piece blank part with a receiving element which has already been fastened.

Moreover, the invention is based on the advantage that an offset of the pattern or design between the individual separate blank parts in the prior art, which offset occurs, for example, as a consequence of during the inkjet printing, is avoided reliably in the case of the single-piece blank part according to the invention for the seat cover.

If a blank part is produced by means of cutting, a defined part of the raw material is what is known as waste in a manner which is related to the process, which waste is usually not required for further production of the seat cover. By means of the single-piece blank part according to the method for a seat cover, a number of operating steps to be carried out, in particular cuts to size to be carried out on the raw material, is reduced significantly. Therefore, considerably less waste arises in comparison with the prior art, a particularly high cost saving and less complicated processing being achieved in an advantageous way.

One development of the method provides that a seat face-side body contact surface and two seat face-side side cheek surfaces are cut to size as a single-piece seat face blank part. Therefore, the number of cuts to size to be carried out on the raw material for a seat face (also called a seat face-side seat cover) for the production of a seat cover is reduced significantly in comparison with the prior art, with the result that the waste is considerably lower.

In another development of the method, a backrest-side body contact surface and two backrest-side side cheek surfaces are cut to size as a single-piece backrest blank part. Therefore, the number of cuts to size to be carried out on the raw material for a backrest (also called a backrest-side seat cover) for the production of a seat cover is reduced significantly in comparison with the prior art, with the result that the waste is considerably lower.

In a further embodiment, before the single-piece blank part is cut to size, the receiving element is arranged and fastened on the raw material in a transition region between the body contact surface and the respective side cheek surface. There is a receptacle for an insert by means of the receiving element which has already been fastened to the raw material, which insert serves to configure and support a contour of the seat cover. In contrast to the prior art, manual fastening of the receiving element to the blank parts which have already been cut in a trimming unit is dispensed with. The processing of the single-piece blank part in the trimming unit is simplified by way of the pre-fixing by machine on the raw material, as a result of which a further cost saving is achievable.

One refinement of the method provides that a continuous tube for receiving an insert, in particular a tubular element, is fastened as a receiving element to the raw material. The receiving element with the insert, in particular a rod-shaped or tubular element, serves to contour the seat cover in the interface region or separating region between the body contact surface and the respective side cheek surface and to fix the seat cover on a foam part or a seat cushion part of a seat, in particular of a vehicle seat, with the result that a movement or slipping of the seat cover is prevented. By means of the receiving element, in particular the continuous tube, the insert, for example a tubular element, can be arranged on the seat cover and optimum securing of the insert on the seat cover is ensured.

As an alternative or in addition, the receiving element is provided for receiving an insert which has a shape which differs from the tubular or rod shape.

In a further refinement of the method according to the invention, a segmented tube for receiving the insert is fastened as a receiving element to the raw material. A material requirement for the receiving element is minimized in an advantageous and simple way by means of segmentation.

Another development provides that the receiving element is arranged and fastened on, in particular sewn to, the raw material by means of a computer-controlled machine, in particular what is known as a CNC machine. By means of the arrangement and fastening of the receiving element on the raw material by machine, the number of manual operating steps is reduced.

In a further refinement, the receiving element is fastened to the raw material by means of a sewing machine. To this end, the receiving element is fastened to the raw material by means of what is known as an open seam, in the case of which, in contrast to a closed seam, a sewing thread is visible on the outer surface side on the finished seat cover. On account of the mechanical fastening of the receiving element to the seat cover by means of a sewing machine, a permanent connection which is gentle on material is produced, in contrast with, for example, the known conventional hot melt adhesive connection. In other words: the open seam is provided, in order to configure the usual division between the body contact surface and the side cheek surfaces in a visually discernible manner. Here, colors of the sewing thread which are visually discernible and pleasant can be used in an advantageous way.

A seat cover, produced in accordance with the method according to the invention, can be produced in an advantageous way by means of a reduced number of operating steps in comparison with the prior art, as a result of which a significant cost saving can be achieved. The seat cover is suitable, in particular, for a vehicle seat which has laterally formed side cheeks in the seat face and in the backrest.

Exemplary embodiments of the invention will be explained in greater detail using drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a diagrammatic plan view of a raw material for seat cover production with markings for a plurality of single-piece blank parts with receiving elements which have already been fastened to them;

FIG. 2 is a diagrammatic plan view of a plurality of blank parts of a multiple-piece seat face seat cover in accordance with the prior art;

FIG. 3 is a diagrammatic plan view of one exemplary embodiment of a single-piece seat face blank part;

FIG. 4 is a diagrammatic plan view of a plurality of blank parts of a multiple-piece backrest seat cover in accordance with the prior art;

FIG. 5 is a diagrammatic view of one exemplary embodiment of a single-piece backrest blank part;

FIG. 6 is a diagrammatic plan view of one exemplary embodiment of a single-piece seat face blank part with a fastened receiving element;

FIG. 7 is a diagrammatic plan view of one exemplary embodiment of a single-piece seat face blank part with a further exemplary embodiment for a fastened receiving element;

FIG. 8 is a diagrammatic view showing one exemplary embodiment for a flow chart of a production process for seat covers; and

FIG. 9 is a diagrammatic view showing one exemplary embodiment for a flow chart of a production process for seat covers.

### DESCRIPTION OF THE PREFERRED EMBODIMENTS

Referring to the drawings, parts which correspond to one another are provided with the same designations in all figures.

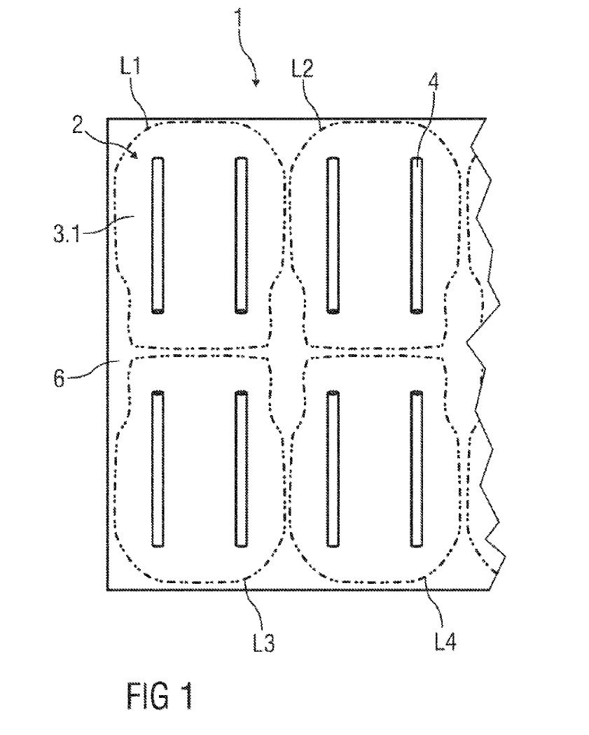

FIG. 1 shows one possible exemplary embodiment of a raw material 1 which is provided for producing a seat cover 2 (shown in greater detail in the following figures). The raw material 1 is a textile, for example a cloth, and is configured in the form of what is known as a cloth web which has a defined width and a defined length. As an alternative, the raw material 1 is a leather or another material which is suitable as a seat cover 2.

The web-shaped raw material 1 is provided with markings in the form of lines L1 to L4 for a plurality of single-piece seat face blank parts 3.1 of a plurality of seat covers 2. FIG. 1 shows that surface side of the raw material 1 which, in the case of the respective seat cover 2, forms its underside, by way of which the seat cover 2 bears against a carrier, in particular a foam body or another cushion element.

The lines L1 to L4 which are shown are respective markings for a single-piece seat face blank part 3.1 of the seat cover 2, which markings depict a predefined cutting sequence, in order to realize specific seat contours and seat dimensions by means of cutting to size by machine or manually.

A region of the raw material 1 which is situated on the outside around the lines L1 to L4 is not used during the further production of the seat cover 2 and is called waste 6. The lines L1 to L4 can be applied, for example, graphically on the raw material 1 by means of a stencil and a drawing element. As an alternative, if the seat face blank parts 3.1 are cut out in a computer-controlled manner, the lines L1 to L4 are not applied on the raw material 1, since they are generated on the software side in a digitized manner.

In exemplary embodiments which are not shown, the lines L1 to L4 are markings for blank parts of other shapes, in particular for backrest blank parts 3.2, as shown in FIG. 5.

At least one receiving element 4 is arranged and fastened on the raw material 1 on the surface side which forms the underside of the seat cover 2, in the region of the respectively marked single-piece seat face blank part 3.1.

In one possible embodiment, before the respective single-piece seat face blank part 3.1 is cut to size from the raw material 1, the receiving element 4 is fastened mechanically to the raw material 1, in particular is sewn to the raw material 1. Here, the receiving element 4 is fastened to the raw material 1 by means of a sewing machine using what is known as an open seam 5.

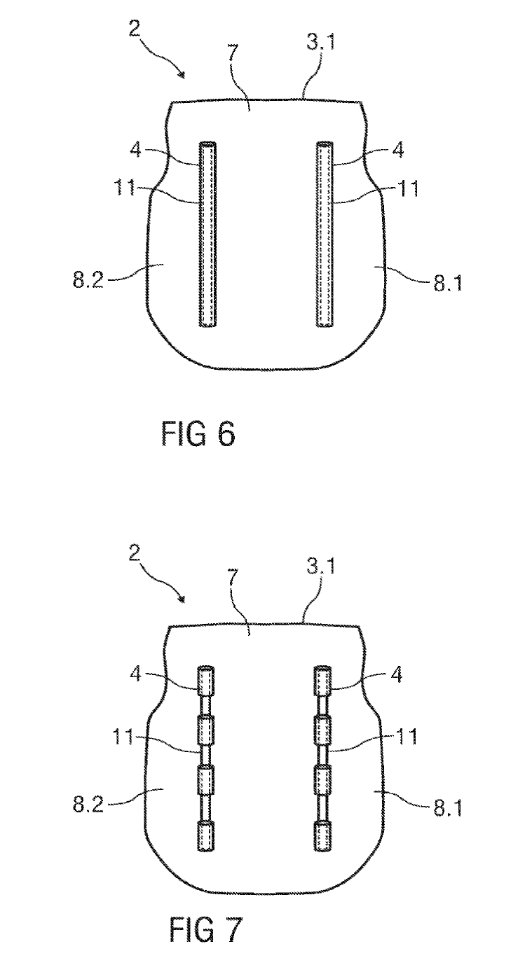

The receiving element 4 serves as a receptacle for an insert 11 (shown in FIGS. 6 and 7) or an element which is such that it gives a contour to the seat cover 2. The insert 11 is held and fixed on the seat cover 2 by means of the receiving element 4. The receiving element 4 is formed, for example, from plastic or another flexible and sufficiently stable material.

The receiving element 4 is arranged and fastened on the inner side or underside of the seat cover 2 and therefore on that surface side of the seat cover 2 which lies opposite the use side. The receiving element 4 protrudes in the manner of a tubular bead from the underside of the seat cover 2. By means of the receiving element 4 on its own and/or together with the insert 11 which is arranged and held therein, the seat cover 2 is held in the mounted state in a positionally correct manner on a carrier or cushion element of a vehicle seat and is fixed in a manner which is largely secured against slipping.

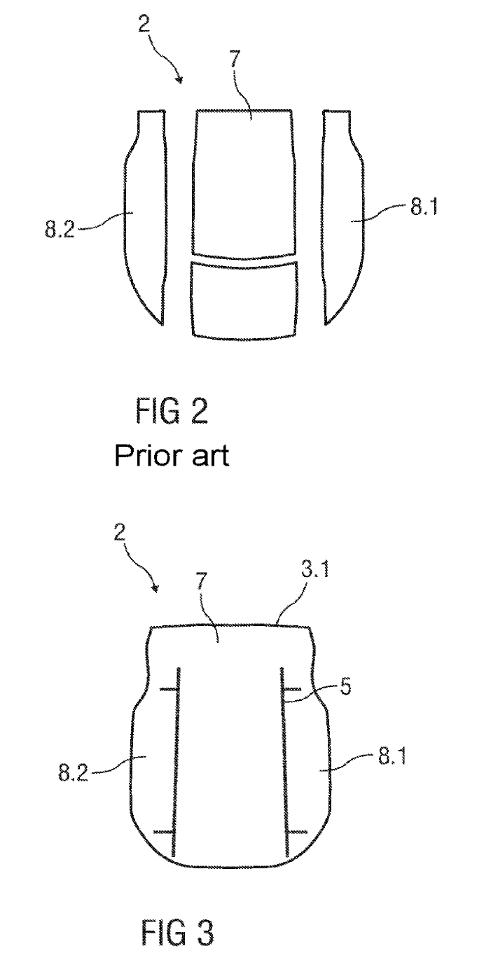

FIG. 2 shows a seat face-side body contact surface 7 and two seat face-side side cheek surfaces 8.1, 8.2 of the seat cover 2 in accordance with the prior art. The seat face-side body contact surface 7 and the two seat face-side side cheek surfaces 8.1, 8.2 are cut out separately and are connected to one another, in particular sewn together, in a further operating step in a trimming unit, the receiving element 4 (not shown here) being arranged, in contrast to the exemplary embodiment which is shown in FIG. 1, on a joining seam which results therefrom, and being fastened by means of said joining seam.

FIG. 3 shows one exemplary embodiment of a single-piece seat face blank part 3.1 for a seat face of a vehicle seat. FIG. 3 shows the single-piece seat face blank part 3.1 in a plan view of the upper side which is visually discernible for a user of the seat.

Here, the single-piece seat face blank part 3.1 comprises a seat face-side body contact surface 7 and two adjoining seat face-side side cheek surfaces 8.1, 8.2, and the seam 5 which is visually discernible from outside. In contrast to FIG. 2, the seat face-side body contact surface 7 and the two seat face-side side cheek surfaces 8.1, 8.2 are cut out in one piece as a common seat face blank part 3.1.

As an alternative, the seam 5 can be merely a decorative seam which is introduced into the raw material 1 in the interface or dividing region between the body contact surface 7 and the respective adjoining side cheek surface 8.1 and 8.2. In this case, the receiving element 4 is fastened to the raw material 1 in another suitable way, for example is connected to it in an integrally joined manner, in particular is adhesively bonded, on the underside of said raw material 1.

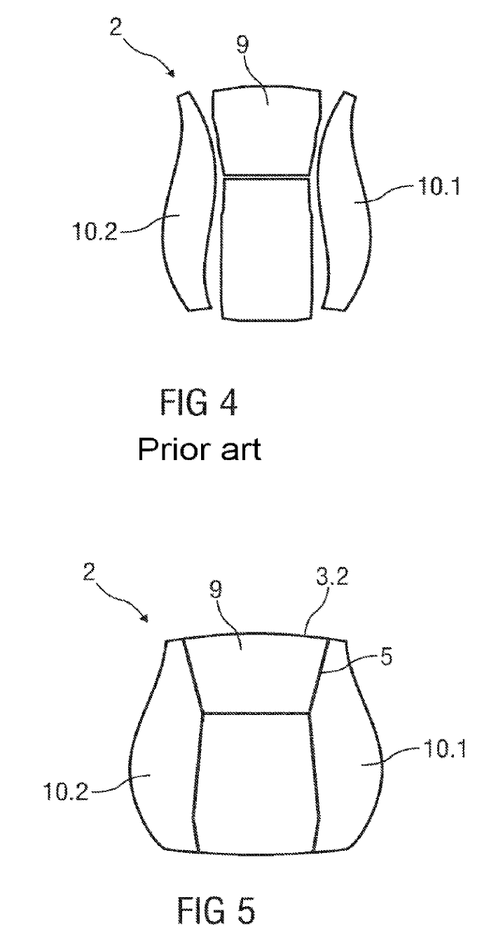

FIG. 4 shows a backrest-side body contact surface 9 and two adjoining backrest-side side cheek surfaces 10.1, 10.2 of the seat cover 2 in accordance with the prior art. The backrest-side body contact surface 9 and the two backrest-side side cheek surfaces 10.1, 10.2 are cut out separately and are connected to one another in the further operating step, in particular are sewn together by means of a joining seam.

FIG. 5 shows one exemplary embodiment of a single-piece backrest blank part 3.2 for a backrest of the vehicle seat. FIG. 5 shows the single-piece backrest blank part 3.2 with the seam 5 in a plan view of the upper side which is visually discernible for a user of the seat with a fitted seat cover 2.

Here, the single-piece backrest blank part 3.2 comprises a backrest-side body contact surface 9 and two adjoining backrest-side side cheek surfaces 10.1, 10.2 which are separated visually from one another by means of the seam 5, but are not joined by means of said seam 5. In contrast to FIG. 4, the backrest-side body contact surface 9 and the two backrest-side side cheek surfaces 10.1, 10.2 are cut out in one piece as a common backrest blank part 3.2.

FIG. 6 shows one exemplary embodiment for an underside of a single-piece seat face blank part 3.1 with a fastened receiving element 4 which is configured as a continuous tube for receiving an insert 11, for example a tubular element. The receiving element 4 is arranged and fastened on the seat face blank part 3.1 by means of the seam 5 and extends over a predefined region which is configured in accordance with the contour of the finished vehicle seat. Here, the seam 5 can serve on the outer side as a contour-giving decorative seam of the seat cover 2.

The insert 11 extends along the receiving element 4 and is formed, for example, as a tube or rod made from plastic or metal. The receiving element 4 which protrudes from the underside with the insert 11 imparts to the seat cover 2 the contour at the transitions between the body contact surface 7 and the side cheek surfaces 8.1, 8.2 and, in addition, serves to secure and fix the seat cover 2 on a carrier, in particular on a foam part or a seat cushion part of the vehicle seat, in a positionally correct manner and such that it is secured substantially against slipping, with the result that a displacement or sliding of the seat cover 2 is at least reduced or is prevented.

FIG. 7 shows a second exemplary embodiment of the receiving element 4. In contrast to FIG. 6, said receiving element 4 is of segmented configuration.

The pre-sewing of components, such as the receiving element 4, to the raw material 1 before the cutting to size process reduces the production process and the manual work considerably in comparison with conventional production methods. Furthermore, the cutting to size operation can already be carried out briefly after the laminating operation has ended, with the result that the single-piece blank parts 3.1, 3.2 which are produced can be fed to further process steps and process locations, without it being necessary for the waste which arises during the cutting to size process to be transported.

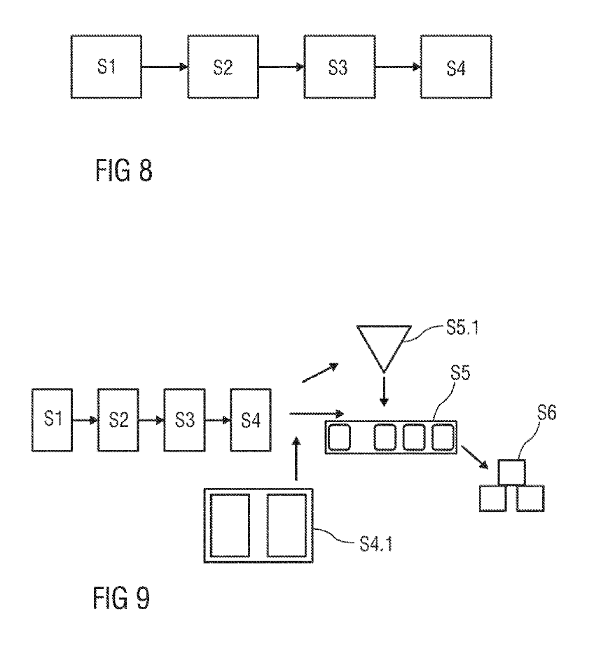

FIGS. 8 and 9 in each case show one exemplary embodiment for a flow chart of a production process for the above-described seat covers 2 with prefixed receiving elements 4.

In the exemplary embodiment according to FIG. 8, the raw material 1 which is provided for a seat cover 2 is finished, in particular coated, in a first step S1. The raw material 1 is usually fed to the process in endless webs. The raw material 1 is a textile, in particular a woven fabric, a cloth or leather. In the step S1, the raw material 1 is finished, for example by means of a laminating or coating process, preferably a flame laminating process.

In a following optional second step S2, the raw material 1 is wound onto what are known as reels.

As an alternative, the raw material 1 can be pre-sewn in a third step S3 after the laminating or coating in the step S1. For the case where the pre-sewing is carried out at a location which is remote from the laminating or coating, the laminated or coated raw material 1 is wound onto reels in the step S2 for transport to the next process step.

In a following third step S3, as described above using FIGS. 1, 6 and 7, the raw material 1 is provided with receiving elements 4 (also called fastening elements) on the surface side which forms the underside of the seat cover 2, which receiving elements 4 are sewn and fastened to the raw material 1 in one or more sewing steps by means of seams 5 in a fully automatic manner, for example by means of computer-controlled sewing machines. Here, the receiving elements 4 are sewn to the raw material 1 by means of the seams 5 in such a way that said seams 5 serve firstly for fastening and secondly as a decorative seam on the outer side or upper side of the finished seat cover 2.

As an alternative, the receiving elements 4 can be fastened fully automatically by means of another connecting type, for example can be riveted or connected in an integrally joined manner. In an analogous manner to the seam 5, the rivets serve to fasten the receiving elements 4 to the underside of the finished seat cover 2 and as decorative rivets on the upper side or outer side. The inserts 11 are optionally introduced into the fastened receiving elements 4.

Depending on the location of the respective production method, the raw material 1 which is provided with the fastened receiving elements 4 can be wound onto reels again for transport to the next location (in an analogous manner to the step S2).

The raw material 1 which is provided with the receiving elements 4 and is pre-sewn by machine is subsequently fed in a fourth step S4 to a cutting process, for example in what is known as a trimming unit, in which the above-described single-piece seat face blank parts 3.1 and/or the single-piece backrest blank parts 3.2 are cut from the raw material 1 by means of a cutting tool, for example what is known as a cutter.

After the cutting process in the step S4 in a trimming unit, the cut single-piece seat face blank parts 3.1 and/or the single-piece backrest blank parts 3.2 are optionally packed and fed to a sewing factory or a manufacturing factory for seats, in particular vehicle seats, and are processed there to produce seat covers 2 for vehicle seats.

The sequence of the production method according to FIG. 9 is substantially identical as far as the step S4. FIG. 9 shows the sewing process for producing seat covers 2 in a further step S5.

Here, in addition to the single-piece seat face blank parts 3.1 and/or the single-piece backrest blank parts 3.2 with receiving elements 4 which are sewn on from step S4, further required parts which are to be sewn are fed to the step S5 from another cutting process of a step S4.1.

Depending on the type and design of the seat cover 2 to be manufactured, the single-piece seat face blank parts 3.1 and/or the single-piece backrest blank parts 3.2 and/or the further required parts can be fed in a step S5.1 to additional fully automatic processing operations, such as embossing, high frequency welding or further pre-sewing.

In the actual step S5 (the sewing process for finishing of the seat cover 2), the pre-sewn and/or pre-processed single-piece seat face blank parts 3.1 and/or the single-piece backrest blank parts 3.2 and/or the further required parts are then crafted to form the respective seat cover 2 in a plurality of sewing steps which are carried out semiautomatically and/or manually.

Said seat cover 2 is then packaged in an optional step S6 for further transport to a remote production location or is processed further directly in a manufacturing plant for vehicle seats.

While specific embodiments of the invention have been shown and described in detail to illustrate the application of the principles of the invention, it will be understood that the invention may be embodied otherwise without departing from such principles.

1. A method for producing a seat cover which comprises at least one body contact surface and adjoining side cheek surfaces, the method comprising the steps of:
providing a raw material for the seat cover from which a blank part is to be cut;
before the blank part for the seat cover is cut, arranging at least one receiving element and fastening the at least one receiving element on the raw material in the region of the blank part to be cut.

2. The method as claimed in claim 1, wherein the at least one body contact surface and the adjoining side cheek surfaces are cut to size from the raw material such that the blank part is a single-piece blank part for the seat cover.

3. The method as claimed in claim 2, wherein a seat face-side body contact surface and two seat face-side side cheek surfaces are cut to size from the raw material such that the blank part is a single-piece blank part for the seat cover.

4. The method as claimed in claim 2, wherein a backrest-side body contact surface and two backrest-side side cheek surfaces are cut to size from the raw material such that the blank part is a single-piece backrest blank part.

5. The method as claimed in claim 2, wherein, before the single-piece blank part is cut to size, the receiving element is arranged and fastened on the raw material in a transition region between the body contact surface and the adjoining side cheek surface.

6. The method as claimed in claim 2, wherein a continuous tube for receiving an insert is fastened as the receiving element to the raw material.

7. The method as claimed in claim 2, wherein a segmented tube for receiving an insert is fastened as the receiving element to the raw material.

8. The method as claimed in claim 2, wherein the receiving element is arranged and fastened on the raw material by means of a computer-controlled machine.

9. The method as claimed in claim 8, wherein the receiving element is sewn onto the raw material by means of a sewing machine.

10. A seat cover comprising:
at least one body contact surface; and
adjoining side cheek surfaces, wherein the seat cover is formed by a method comprising the steps of:
providing a raw material for the seat cover from which a blank part is to be cut;
before the blank part for the seat cover is cut, arranging at least one receiving element on the raw material in a region of the blank part to be cut and fastening the at least one receiving element on the raw material in the region of the blank part to be cut.

11. The seat cover as claimed in claim 10, further comprising cutting the blank part to size from the raw material as a single-piece blank part for the seat cover including the at least one body contact surface and the adjoining side cheek surfaces that are cut to size from the raw material.

12. The seat cover as claimed in claim 11, wherein the at least one body contact surface comprises a seat face-side body contact surface and the adjoining side cheek surfaces comprise two seat face-side side cheek.

13. The seat cover as claimed in claim 12, wherein the at least one body contact surface further comprises a backrest-side body contact surface.

14. The seat cover as claimed in claim 11, wherein, before the single-piece blank part is cut to size, the receiving element is arranged and fastened on the raw material in a transition region between the body contact surface and the adjoining side cheek surface.

15. The seat cover as claimed in claim 11, wherein a continuous tube for receiving an insert is fastened as the receiving element to the raw material.

16. The seat cover as claimed in claim 11, wherein a segmented tube for receiving an insert is fastened as the receiving element to the raw material.

17. The seat cover as claimed in claim 11, wherein the receiving element is arranged and fastened on the raw material by means of a computer-controlled machine.

18. The seat cover as claimed in claim 17, further comprising sewing the receiving element onto the raw material with a sewing machine.

19. A method for producing a seat cover, the method comprising the steps of:
providing a raw material for the seat cover from which a blank part is to be cut;
arranging at least one receiving element on the raw material in a region of the blank part to be cut;
fastening the arranged receiving element on the raw material in the region of the blank part to be cut;
cutting the blank part, with the fastened receiving element, to size from the raw material as a single-piece blank part for the seat cover with the single-piece blank part including at least one body contact surface and the adjoining side cheek surfaces that are cut to size from the raw material.

20. The method for producing a seat cover as claimed in claim 19, wherein the at least one body contact surface comprises a seat face-side body contact surface a backrest-side body contact surface and the adjoining side cheek surfaces comprise two seat face-side side cheek surfaces.
